(19) United States
(12) Patent Application Publication
(10) Pub. No.: US 2026/0188328 A1
(43) Pub. Date: Jul. 2, 2026

(54) NatureScope: A Smart AI-Driven Exploration Device for Natural Discovery and Learning

(71) Applicant: Richard Bell, Ashtead (GB)

(72) Inventor: Richard Bell, Ashtead (GB)

(21) Appl. No.: 19/006,368

(22) Filed: Dec. 31, 2024

(51) Int. Cl. G10L 17/26; G10L 17/18

(52) U.S. Cl. CPC G10L 17/26; G10L 17/18

(57) ABSTRACT

NatureScope is an innovative, AI-powered educational exploration device designed to inspire children to discover and learn about the natural world. Equipped with a high-sensitivity microphone for capturing bird calls alongside a camera module for images of plants and insects, NatureScope uses a sophisticated AI Identification System to provide real-time audio and visual identification and educational content on an integrated LCD screen. Designed ergonomically for young explorers, the device supports offline functionality, facilitating exploration in remote areas. It includes features such as a specimen collection tray and options for magnifying lenses or microscope attachments to enhance detailed study. NatureScope offers various educational modes, such as Audio Explorer and Microscope Modes, with content dynamically tailored to seasonal, geographic, and age-specific variations, enhancing STEM learning opportunities.

### TECHNICAL DESCRIPTION OF INVENTION

NatureScope is an AI-enhanced educational device featuring a high-sensitivity microphone and camera module, designed to identify bird calls and natural objects in real-time, offering tailored educational content on an LCD screen, with offline functionality and modular expandability for comprehensive STEM learning.

### BACKGROUND OF INVENTION

The background of the invention, “NatureScope,” emerges from the need to provide engaging and educational tools that foster a deeper connection between children and the natural environment. Traditional learning tools often lack interactivity and fail to stimulate curiosity, especially in outdoor settings. Moreover, with growing awareness of the importance of STEM education, there is a pressing demand for devices that can make learning science, technology, engineering, and mathematics more accessible and enjoyable.

Conventional exploration tools, like magnifying glasses or field guides, offer limited functionality and require supplementary resources to assist in the identification and understanding of natural objects. Many existing digital tools depend heavily on internet connectivity, which restricts their use in outdoor environments where such connectivity may be unavailable. This presents a challenge in ensuring seamless learning experiences in such contexts.

In response to these limitations, NatureScope is designed to seamlessly combine modern AI technology with practical exploration features, enabling children to identify objects and learn about nature in real-time. Its offline capabilities ensure that learning is uninterrupted, regardless of location. The multifunctional design not only makes it easy for children to engage with and explore their surroundings, but also supports a broader STEM curriculum by bridging hands-on learning with technological innovation.

The invention also addresses safety concerns, with built-in alerts for identifying potentially harmful objects, thereby promoting secure exploration. By adapting learning content based on geography and seasons, NatureScope ensures that users receive relevant and timely information, further enriching their educational experience.

Overall, the development of NatureScope is rooted in the desire to enhance traditional exploratory learning with advanced, interactive technology, offering a comprehensive solution for modern educators and parents aiming to inspire the next generation of curious scientists and environmentalists.

### SUMMARY OF INVENTION

NatureScope is a groundbreaking educational device designed specifically for children, offering a unique blend of cutting-edge AI technology and practical, hands-on features to facilitate exploration and learning about the natural world. This innovative tool empowers young explorers to engage deeply with their environment, all while supporting educational objectives aligned with STEM principles.

Central to NatureScope's functionality is its sophisticated AI Identification System. This system enables users to effortlessly scan and accurately identify a diverse range of natural objects, including plants, insects, and other elements of nature, using an integrated camera module. The AI system is enhanced with an advanced accuracy predictor, which not only displays percentage confidence levels for each identification but also provides follow-up prompts that refine the recognition process. These interactive features encourage users to delve deeper into the learning process, fostering critical thinking and curiosity.

One of the standout features of NatureScope is its robust offline capability, allowing the device to operate seamlessly in remote environments where internet access may be unavailable. This function makes NatureScope particularly useful for outdoor exploration, enabling children to connect with nature in a variety of settings and learn without constraints. The device's ergonomic, child-friendly design includes a specimen collection tray where children can safely store and observe their findings. Additionally, it offers magnifying lenses and optional microscope attachments, enhancing the detail and depth of study for young learners.

The built-in LCD screen is another pivotal feature, serving as the primary interface for displaying real-time identification results and providing educational content. This screen, in conjunction with an LED ring light, ensures clear and vivid imagery even under challenging lighting conditions, which is crucial for accurate identification and study. NatureScope is designed to offer a range of operational modes to cater to diverse learning experiences. “Explorer Mode” is tailored for outdoor field explorations, where children can wander and discover various natural elements. In contrast, “Microscope Mode” focuses on detailed inspections of collected specimens, promoting an interactive and engaging educational experience. These modes are complemented by dynamic educational missions and challenges, which automatically adjust based on factors such as seasonal changes and the geographic location of the user. This adaptability not only engages users but also enriches their understanding of the natural world around them.

To extend its utility, NatureScope supports both physical customization and software expansion, providing a platform for new modes, missions, and educational content to be introduced over time. The device is compatible with a companion application, which allows users to sync their discoveries, track progress on missions, and access additional educational materials. This app support reinforces the educational experience by enabling continuity and personalized learning pathways.

Moreover, the device includes enhanced safety alerts to inform users about potentially hazardous species, ensuring a safe and informed exploration process. By integrating safety and educational utility, NatureScope equips children with the tools to safely engage with their environment while also supporting their educational journey. Overall, NatureScope aims to inspire children to connect with the natural world, fostering a genuine interest in science and nature. Through its advanced features, it helps young explorers develop observational skills, critical thinking, and an appreciation for the environment, ultimately encouraging them to become informed and enthusiastic participants in the exploration of our planet. This device is more than just a tool; it is a gateway to a broader understanding and respect for the natural world, designed to cultivate a lifelong passion for learning and discovery.

### DETAILED DESCRIPTION OF INVENTION

In recent years, the study and enjoyment of birdwatching have grown significantly, necessitating advanced tools for accurate bird call identification. Traditional methods often struggle with background noise and lack the precision needed for specific species recognition. Our invention addresses these challenges by integrating cutting-edge hardware and software to deliver unparalleled accuracy and user adaptability. This invention presents a sophisticated system for bird call recognition and analysis, combining high-sensitivity hardware with advanced machine learning algorithms. It is designed to cater to both enthusiasts and professionals, offering customizable features that enhance user experience and educational value.

At the heart of our system is a high-sensitivity microphone with an exceptional signal-to-noise ratio (SNR). This ensures that even the faintest bird calls are captured with clarity. Directional microphones are employed to focus on specific sounds, effectively minimizing interference from ambient noise. This precision is crucial for accurate species identification, particularly in environments with diverse soundscapes.

The system incorporates a robust audio processing chip capable of performing local analysis of captured sounds. This chip executes basic audio filtering and feature extraction, isolating relevant audio signals from extraneous noise. By processing data locally, the system reduces latency and enhances real-time analysis capabilities, making it ideal for field use. Our system leverages the Cornell Lab of Ornithology's BirdNET API, renowned for its advanced AI capabilities in identifying bird species by sound. This integration allows users to access a vast database of bird calls, ensuring comprehensive recognition across various species. For regions with unique avian populations, the system supports custom model training using Google's TensorFlow audio recognition framework. This flexibility enables users to tailor the system to their specific geographical needs, enhancing its utility in diverse environments.

The AI component of our system meticulously analyzes sound patterns, focusing on frequency, pitch, and duration. By matching these parameters against a detailed database, the system achieves high accuracy in species identification. This process is crucial for distinguishing between similar-sounding calls and ensuring reliable results.

Advanced algorithms are employed to filter out background noise, such as wind, human voices, and vehicular sounds. These algorithms are designed to adapt to varying environmental conditions, maintaining accuracy even in challenging acoustic settings. This innovation sets our system apart, providing users with clear and precise call recognition.

The system is designed with user adaptability in mind, offering configurable settings that cater to different age groups and expertise levels. For instance, educational outputs can be tailored to suit a 6-year-old's understanding or provide detailed insights for a 13-year-old. This adaptability enhances the system's educational value and broadens its appeal.

Our invention is versatile, serving as an invaluable tool for educational purposes, wildlife research, and hobbyist birdwatching. Its adaptability and precision make it suitable for a wide range of applications, from classroom settings to professional field studies.

Compared to existing solutions, our system offers superior sensitivity, accuracy, and user customization. Its ability to filter noise and adapt to user needs makes it a standout choice for anyone interested in bird call recognition and analysis.

NatureScope is an advanced, modular educational exploration device engineered to revolutionize how young learners interact with and understand the natural environment. By merging cutting-edge AI with ergonomic and adaptable hardware, this device offers an immersive learning experience that fosters curiosity and scientific inquiry outside traditional classroom settings while continuously adapting to students'evolving educational needs.

The device features a child-friendly, ergonomic design that encourages field use, emphasizing modular expandability through optional add-ons like enhanced lenses and light modules. Its high-resolution camera module captures detailed images of natural objects, supporting accurate identification and educational exploration. For example, a child might use NatureScope to capture an image of a unique flower, initiating detailed analysis facilitated by the AI system.

The captured image is processed by an advanced AI Identification System. This system not only provides rapid and precise identification against an extensive flora and fauna database but also adapts its functionality with in-depth learning prompts and interactive educational trails. Results, alongside an accuracy predictor and potential alternative matches, are displayed on a built-in LCD screen, perfect for verification and deeper inquiry.

Imagine children on a school trip using NatureScope to examine a butterfly. The device captures the image, and the AI swiftly provides identification, including the species name and ecological roles. Interactive educational prompts further engage students, guiding them in refining identifications and exploring butterfly behavior, anatomy, and the surrounding ecosystem.

NatureScope's specimen collection system allows users to store and study objects seamlessly. For instance, a child might collect a leaf for examination using built-in or optional microscope attachments, enhancing understanding of photosynthesis and plant structures through guided observations.

An LED ring light surrounding the camera equips users to capture clear images under varied lighting conditions, like forest canopies or dusk, promoting exploration in diverse environments. This tech integrates with safety features, providing visual and auditory warnings upon identifying hazardous species or objects, enriching safe educational practices.

Offering diverse operational modes, NatureScope enhances learning activities significantly. “Explorer Mode” supports hands-on identification via seasonal and geographically tailored challenges, while “Microscope Mode” facilitates detailed inspections, encouraging critical observational and analytical skills linked to broader ecological principles.

Safety is integral to NatureScope, with alerts for recognizing hazardous or poisonous objects. Warnings educate users about safety precautions while promoting understanding of environmental risks and conservation. The educational value of the device is amplified through a companion app, which syncs discoveries, tracks missions, and provides extended content access. This app offers an interactive platform enhanced by robust privacy measures, ensuring data security and personalized educational pathways.

The ‘Field Atlas’ map mode leverages user location insights to suggest local wildlife coverage. Discoveries can be pinned on a map and supplemented with voice notes, creating a personalized and revisitable learning experience. A distinctive feature of NatureScope is tailoring educational content according to the user's age, such as presenting different levels of complexity about a gray squirrel to a 6-year-old versus a 13-year-old, supporting tailored educational experiences.

NatureScope's adaptability is ensured through periodic software updates introducing diverse missions, expanding databases, and integrating new features like “Game Mode.” This ensures seamless interactive learning, including “citizen science” where users track environmental changes and contribute globally. The device's modular design caters to physical expandability, allowing enhancements like smarter lenses or light modules. This modularity supports continued growth in line with learners'interests and educational needs.

Envision a student receiving NatureScope at the start of their educational journey. Initial interactions focus on basic backyard exploration, gradually progressing to complex scientific concepts and curriculum-aligned missions. By high school, it aids in comprehensive biodiversity projects and broader ecological studies. NatureScope supports progressive learning stages, fostering factual understanding, critical thinking, and analytical skills, igniting a lifelong passion for environmental science. It serves as a trusted companion and catalyst for potential STEM-oriented careers, encouraging diverse learning paths beyond the classroom.

To update the claims for your educational exploration device incorporating bird call recognition and analysis features, we'll need to integrate relevant elements into the claims. Here's how the updated claims might look:

1. An educational exploration device comprising:
a high-sensitivity microphone with a good signal-to-noise ratio (SNR) for capturing bird calls in various environments;
an AI Identification System configured to analyze and identify bird species based on audio patterns in real-time, utilizing pre-trained AI models with regional customization options;
an integrated LCD screen for displaying identification results and educational content;
an ergonomic, child-friendly design with modular expandability;
offline functionality enabling usage without internet access;
the capability to present age-appropriate educational content aligned with STEM learning objectives and specific science curricula;
a noise filtering system that effectively reduces background noise interference for accurate bird call recognition.

1.1. The device of claim 1, wherein the AI Identification System includes an accuracy predictor that presents percentage confidence levels for bird call identification results and adaptive prompts to refine identification results, assist in in-depth learning, and encourage critical thinking about avian species.

1.2. The device of claim 1, further comprising a specimen collection tray or virtual observation log integrated for storing and viewing audio or visual findings, with tooltips for engaging users in enhanced detail studies.

1.3. The device of claim 1, wherein the camera module, if included, is equipped with an LED ring light for capturing clear images in low-light conditions, integrating audio-visual feedback systems for safe exploration, and alerts to identify potentially hazardous audio emissions, such as distress calls or predatory sounds.

1.4. The device of claim 1, offering multiple modes of operation, including an Audio Explorer Mode for bird call missions and an Integrative Mode for combining visual and audio data, supporting dynamic educational missions adapted based on seasonal, geographic data, user age, and educational level.

1.5. The device of claim 1, further comprising a “Field Atlas” audio map mode that uses user location to suggest common bird species to listen for in the area, allowing users to pin audio discoveries and add voice notes for later review when connectivity is available, seamlessly merging offline and online data.

1.6. The device of claim 1, further including a companion app for syncing audio discoveries, tracking educational missions, accessing supplementary content, and providing personalized educational pathways with privacy measures for user data security, including parental control functionalities like monitoring progress and setting time limits.

1.7. The device of claim 1, featuring a modular design accommodating hardware expansion such as enhanced microphones, noise reduction modules, and alternate form factors, with the capability for future software updates introducing new missions, educational challenges, citizen science components, and expanded audio databases, including the potential integration of third-party content or licensing agreements, such as National Geographic tie-ins.

1.8. The device of claim 1, which presents tailored educational content specific to the user's demographic, adapting the presentation style suitable for different ages and levels of complexity, such as varying the detail of information provided about specific bird species, incorporating interactive storytelling features, and data visualization tools like sound mapping and gamified progress tracking.
